(19) United States
(12) Patent Application Publication
(10) Pub. No.: US 2026/0183887 A1
(43) Pub. Date: Jul. 2, 2026

(54) DUSTPROOF STRUCTURE FOR WALL POLISHER

(71) Applicant: SHENZHEN HUIKAIDA TECHNOLOGY CO., LTD, Shenzhen (CN)

(72) Inventor: He Zhang, Guangzhou (CN)

(73) Assignee: SHENZHEN HUIKAIDA TECHNOLOGY CO., LTD, Shenzhen (CN)

(21) Appl. No.: 19/026,343

(22) Filed: Jan. 16, 2025

(30) Foreign Application Priority Data
Dec. 31, 2024 (CN) 2024232906540

(51) Int. Cl. B24B 7/18; B24B 47/12; B24B 55/10; F21V 33/00

(52) U.S. Cl. CPC B24B 7/184; B24B 7/186; B24B 47/12; B24B 55/102; F21V 33/0084

(57) ABSTRACT

A dustproof structure for wall polisher is provided, including an elastic dust cover, an installation cover, and an exhaust dust system. The elastic dust cover is provided with a fixed disk bracket inside. The installation cover is installed on a surface of the motor, one side of the installation cover is provided with a delivery pipe connected to the elastic dust cover, a transmission shaft is provided inside the installation cover, and an exhaust impeller is connected to a top of the transmission shaft. The exhaust dust system is connected to the one side of the installation cover, and one end of the exhaust dust system is connected with a grip rod. By setting the elastic dust cover on the entire device, it can be used to fit with uneven walls according to their shape when the entire device polishes the wall.

### CROSS REFERENCE TO RELATED APPLICATION

This application claims priority to Chinese Patent Application No. 2024232906540, filed on Dec. 31, 2024, which is hereby incorporated by reference in its entirety.

### TECHNICAL FIELD

The present application relates to the technical field of architectural decoration and finishing, and in particular to a dustproof structure for wall polisher.

### BACKGROUND

In the field of architectural decoration, wall polishing is a crucial and frequent process aimed at making the wall flat and smooth, providing a good foundation for subsequent decoration work such as coating and wallpapering. The traditional method of wall polishing mainly relies on manual hand-held sandpaper for polishing. However, such method not only has high labor intensity and low efficiency, but also has difficulty ensuring uniformity in polishing quality. With the advancement of technology, a dustproof structure for wall polisher has emerged, intending to solve many drawbacks of manual polishing.

The polisher is equipped with a simple dust cover, but lacks elastic design. When polishing walls, the flatness of the wall surface is often different, with various complex parts such as protrusions, depressions, and internal and external corners. The rigid dust cover cannot adapt to the undulations of the wall surface, resulting in gaps between the dust cover and the wall surface when polishing these special parts. And dust comes out from the gaps, unable to effectively gather dust, greatly reducing the efficiency of dust collection. In addition, the rigid contact is also prone to scratching the wall, especially on some fragile decorative walls, leaving scratches and damaging the beauty of the wall, subsequent repair work is cumbersome and complex.

During the long-term polishing process of the polisher with a dust cover, the bottom of the dust cover frequently rubs against the wall, which quickly leads to wear and tear. This not only shortens the service life of the dust cover and increases equipment maintenance costs, but also deteriorates the fit between the bottom of the dust cover and the wall after wear, further exacerbating the problems of dust leakage.

Therefore, it is necessary to provide a novelty dustproof structure for wall polisher to address the above problems.

### SUMMARY

The present disclosure aims to provide a novelty dustproof structure for wall polisher to address the problems of dust leakage caused by frequent friction between the bottom of the dust cover and the wall surface during long-term polishing operations of the polisher equipped with a simple dust cover but lacking elastic design and with the dust cover, resulting in a poor fit between the bottom of the dust cover and the wall surface, and further exacerbating the problem of dust leakage.

To achieve above objectives, the present disclosure adopts the following technical solutions. In some embodiments of the present disclosure, a dustproof structure for wall polisher is provided, including an elastic dust cover, an installation cover, and an exhaust dust system.

Herein the elastic dust cover is provided with a fixed disk bracket inside, where a Velcro polishing disc is bonded to a bottom of the fixed disk bracket, an annular brush is provided between the fixed disk bracket and the elastic dust cover, a wear plate is provided at a bottom of the elastic dust cover, a motor is installed at a center position of a surface of the elastic dust cover, and one end of an output shaft of the motor is connected to the fixed disk bracket through a coupling.

Herein the installation cover is installed on a surface of the motor, where one side of the installation cover is provided with a delivery pipe connected to the elastic dust cover, a transmission shaft is provided inside the installation cover, and an exhaust impeller is connected to a top of the transmission shaft.

Herein the exhaust dust system is connected to the one side of the installation cover, and one end of the exhaust dust system is connected with a grip rod.

In some preferred embodiments of the present disclosure, the one side of the installation cover is installed with a vent valve.

In some preferred embodiments of the present disclosure, a rotatable holder is provided between the vent valve and the grip rod.

In some preferred embodiments of the present disclosure, the surface of the elastic dust cover is provided with an annular LED light and the surface of the elastic dust cover is further provided with a LED light switch.

In some preferred embodiments of the present disclosure, the surface of the elastic dust cover is provided with a vent valve switch.

In some preferred embodiments of the present disclosure, a surface of the grip rod is provided with a switch power supply.

In some preferred embodiments of the present disclosure, the surface of the grip rod is provided with a limit component, the limit component includes two fixed rings, two fixed blocks, and a limit rod. Where the two fixed blocks are respectively connected to surfaces of the two fixed rings, the limit rod is connected between the two fixed blocks, and the two fixed rings are symmetrically installed on both sides of the surface of the grip rod.

Compared with related technologies, the dustproof structure for wall polisher of the present disclosure has at least the following beneficial effects.

The dustproof structure for wall polisher of the present disclosure, by setting the elastic dust cover on the entire device, it can be used to fit with uneven walls according to their shape when the entire device polishes the wall. Moreover, by setting the wear plate on one side of the elastic dust cover, so that the device can drive the elastic dust cover to come into contact with the wall for polishing for a long time, this can reduce the wear of the elastic dust cover and causing gaps between the elastic dust cover and the wall, and also can avoid resulting in leakage and falling of wall powder during the polishing process.

### BRIEF DESCRIPTION OF THE DRAWINGS

FIG. 1 shows a structural schematic diagram of a dustproof structure for wall polisher in accordance with some embodiments of the present disclosure.

FIG. 2 shows an enlarged schematic diagram of part A in FIG. 1.

FIG. 3 shows a first cross-sectional view of an entire device of FIG. 1.

FIG. 4 shows an enlarged schematic diagram of part B in FIG. 3.

FIG. 5 shows a second cross-sectional view of the entire device of FIG. 1.

FIG. 6 shows an enlarged schematic diagram of part C in FIG. 5.

FIG. 7 shows a stereo-structural schematic diagram from a first perspective of the entire device of FIG. 1.

FIG. 8 shows an enlarged schematic diagram of part D in FIG. 7.

FIG. 9 shows a stereo-structural schematic diagram from a second perspective of the entire device of FIG. 1.

FIG. 10 shows an enlarged schematic diagram of part E in FIG. 9.

FIG. 11 shows a stereo-structural schematic diagram from a third perspective of the entire device of FIG. 1.

FIG. 12 shows an enlarged schematic diagram of part F in FIG. 11.

FIG. 13 shows another structural schematic diagram of the dustproof structure for wall polisher in accordance with some other embodiments of the present disclosure.

In the drawings, reference signs are as follows. 1. Elastic dust cover, 2. Fixed disk bracket, 3. Velcro polishing disc, 4. Annular brush, 5. Wear plate, 6. Motor, 7. Installation cover, 8. Delivery pipe, 9. Transmission shaft, 10. Exhaust impeller.
11. Vent valve, 12. Exhaust dust system, 13. Annular LED light, 14. LED light switch, 15. Vent valve switch, 16. Rotatable holder, 17. Grip rod, 18. Switch power supply.
19. Limit component, 191. Fixed ring, 192. Fixed block, 193. Limit rod.

### DETAILED DESCRIPTION OF THE EMBODIMENTS

The following will further described the dustproof structure for wall polisher of the present disclosure in conjunction with the accompanying drawings and the specific implementations.

### Embodiments

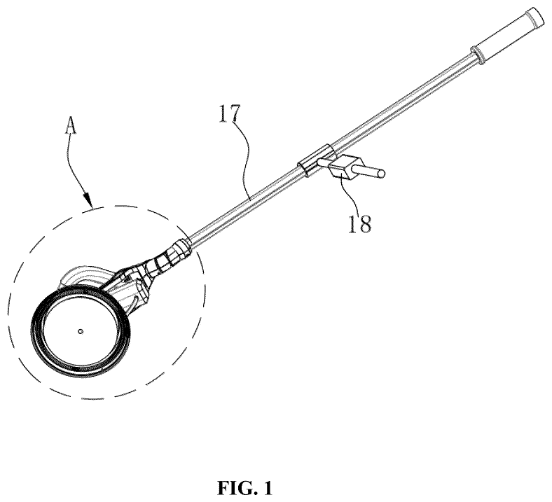

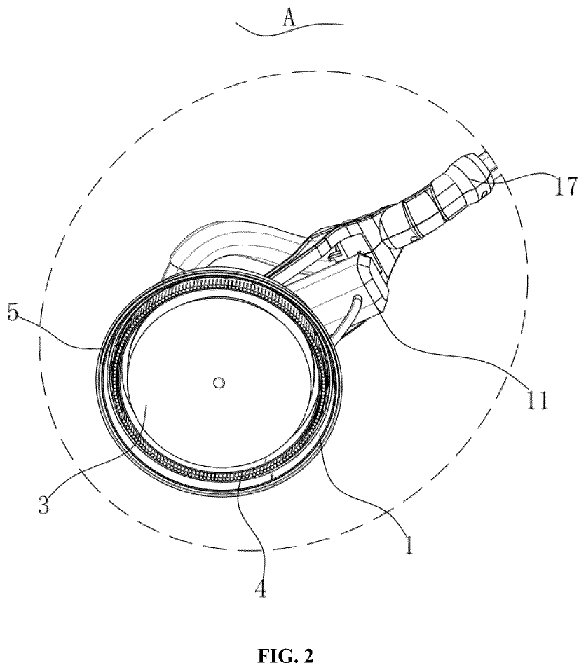

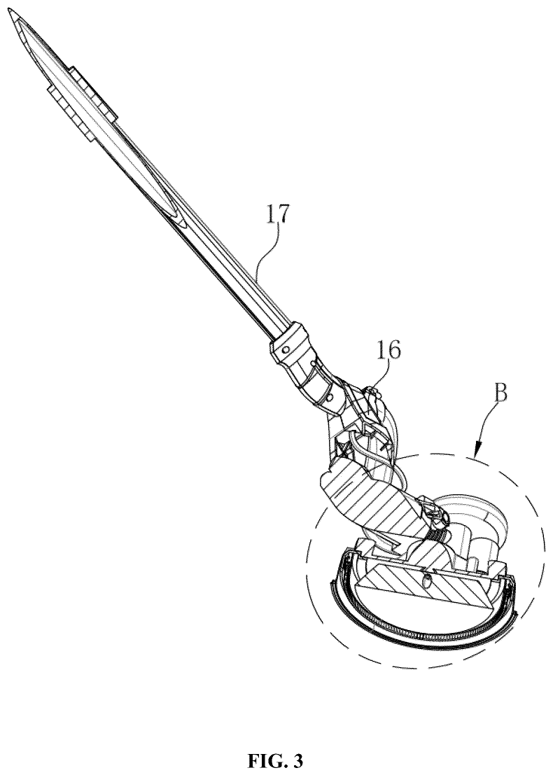

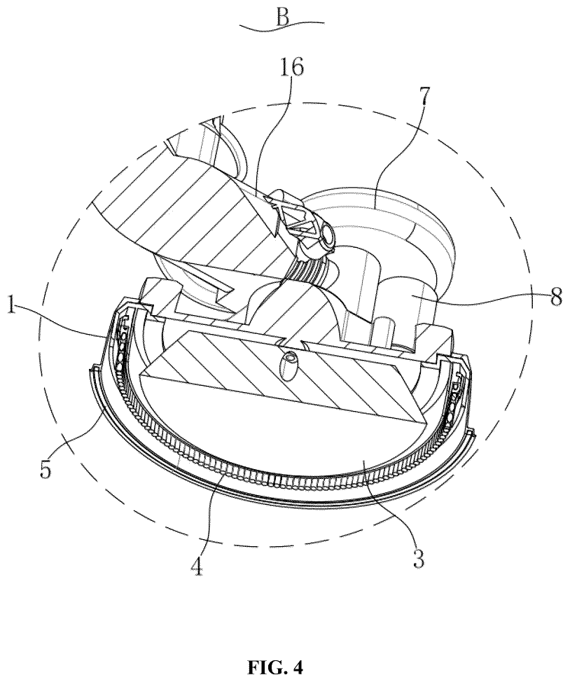

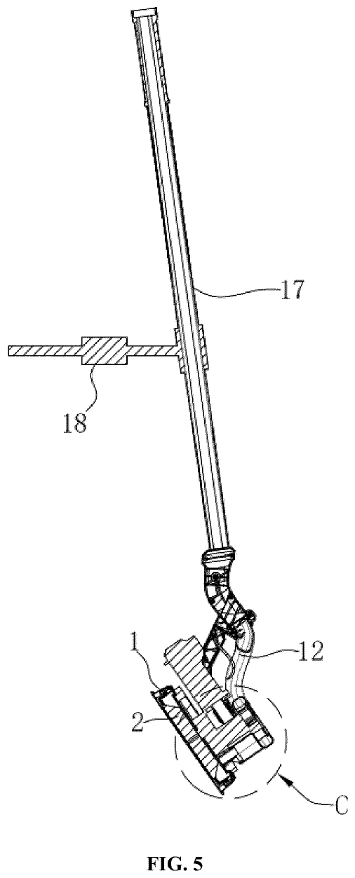

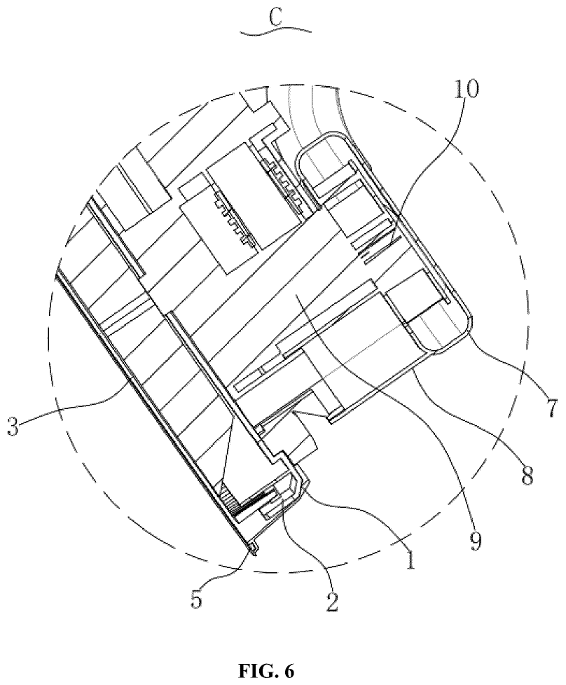

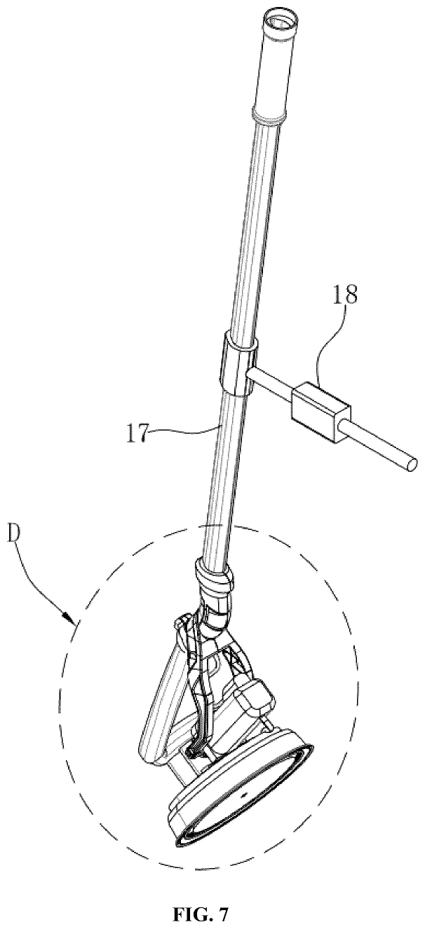

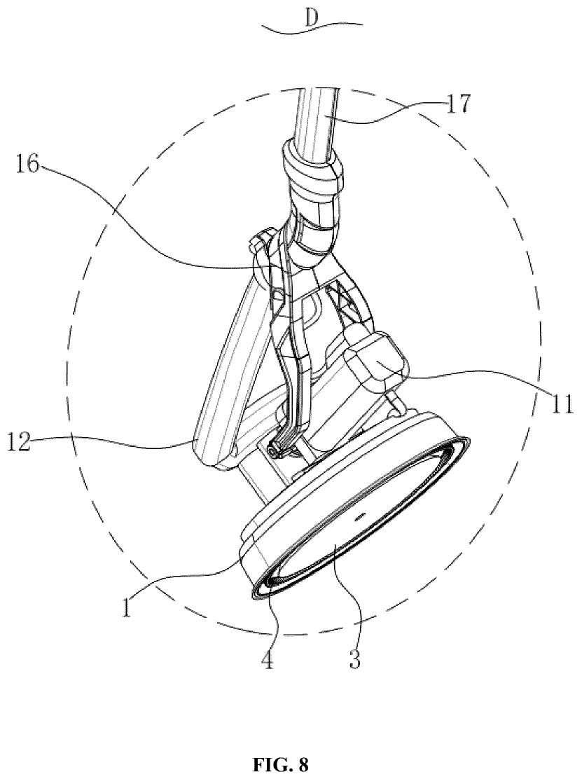

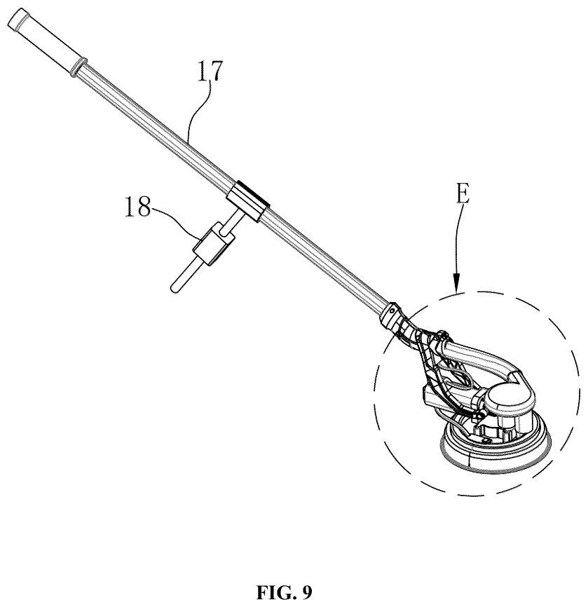

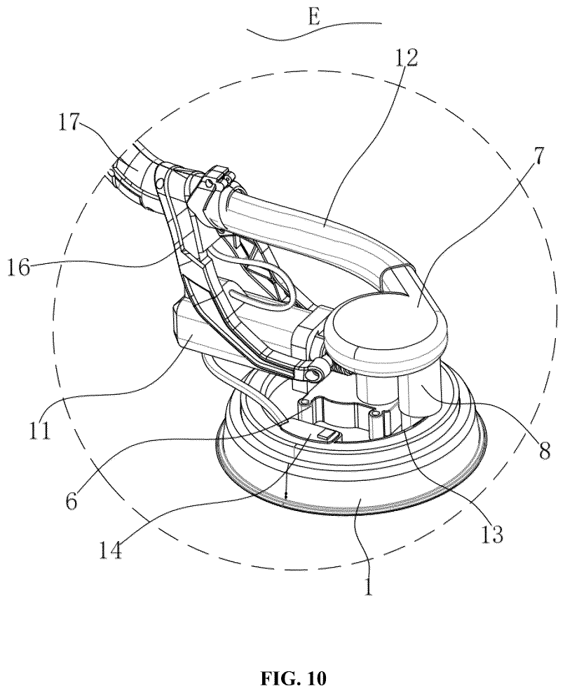

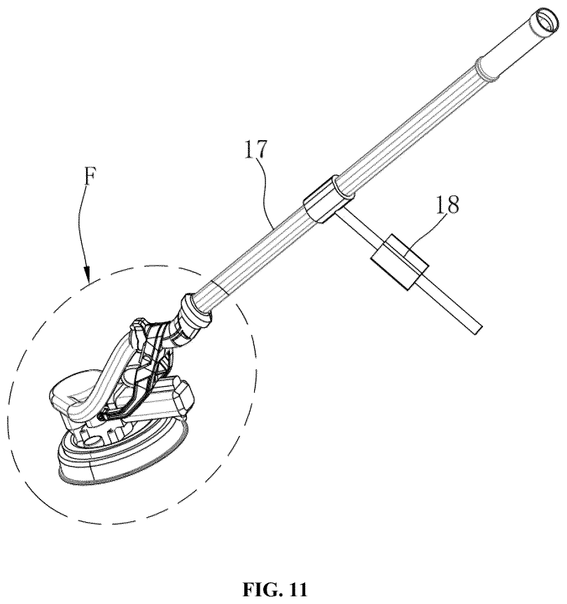

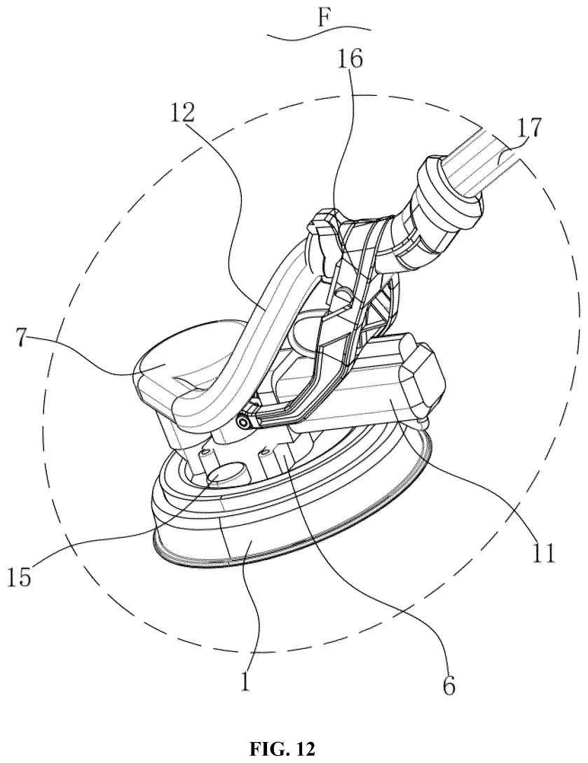

As shown in FIG. 1 to FIG. 12, in some embodiments of the present disclosure, a dustproof structure for wall polisher is provided, including an elastic dust cover 1, an installation cover 7, and an exhaust dust system 12. Herein FIG. 1 shows a structural schematic diagram of a dustproof structure for wall polisher in accordance with some embodiments of the present disclosure, and FIG. 2 shows an enlarged schematic diagram of part A in FIG. 1. FIG. 3 shows a first cross-sectional view of an entire device of FIG. 1, and FIG. 4 shows an enlarged schematic diagram of part B in FIG. 3. FIG. 5 shows a second cross-sectional view of the entire device of FIG. 1, and FIG. 6 shows an enlarged schematic diagram of part C in FIG. 5. FIG. 7 shows a stereo-structural schematic diagram from a first perspective of the entire device of FIG. 1, and FIG. 8 shows an enlarged schematic diagram of part D in FIG. 7. FIG. 9 shows a stereo-structural schematic diagram from a second perspective of the entire device of FIG. 1, and FIG. 10 shows an enlarged schematic diagram of part E in FIG. 9. FIG. 11 shows a stereo-structural schematic diagram from a third perspective of the entire device of FIG. 1, and FIG. 12 shows an enlarged schematic diagram of part F in FIG. 11.

The elastic dust cover 1 is provided with a fixed disk bracket 2 inside, where a Velcro polishing disc 3 is bonded to a bottom of the fixed disk bracket 2, an annular brush 4 is provided between the fixed disk bracket 2 and the elastic dust cover 1, a wear plate 5 is provided at a bottom of the elastic dust cover 1, a motor 6 is installed at a center position of a surface of the elastic dust cover 1, and one end of an output shaft of the motor 6 is connected to the fixed disk bracket 2 through a coupling.

The installation cover 7 is installed on a surface of the motor 6, where one side of the installation cover 7 is provided with a delivery pipe 8 connected to the elastic dust cover 1, a transmission shaft 9 is provided inside the installation cover 7, and an exhaust impeller 10 is connected to a top of the transmission shaft 9.

The exhaust dust system 12 is connected to the one side of the installation cover 7, and one end of the exhaust dust system 12 is connected with a grip rod 17.

The one side of the installation cover 7 is installed with a vent valve 11.

A rotatable holder 16 is provided between the vent valve 11 and the grip rod 17.

The surface of the elastic dust cover 1 is provided with an annular LED light 13 and the surface of the elastic dust cover 1 is further provided with a LED light switch 14.

The surface of the elastic dust cover 1 is provided with a vent valve switch 15.

A surface of the grip rod 17 is provided with a switch power supply 18.

The vent valve 11 installed on the one side of the installation cover 7 is used to balance the internal air pressure of the device, ensuring the normal operation of the exhaust system while avoiding adverse effects on the device caused by pressure differences.

The use of grip rod 17 allows for flexible rotate within a certain range, making it convenient for operators to adjust the angle of the grip rod according to polishing needs and adapt to different working postures and wall positions.

The use of annular LED light 13 is convenient for polishing operations in low light environments, improving the visibility of the work area and ensuring polishing quality.

The use of the vent valve switch 15 is convenient for operators to control the opening and closing degree of the vent valve according to the actual situations, further optimizing the internal air pressure regulation of the device.

The switch power supply 18 provides stable power supply for the entire device.

The elastic dust cover 1 serves as the main protective and dust collection component of the device, containing the fixed dist bracket 2 inside. The Velcro polishing disc 3 at the bottom of the fixed disk bracket 2 can facilitate the replacement of sandpaper with different particle sizes to meet different polishing needs. The annular brush 4 is provided between the fixed disk bracket 2 and the elastic dust cover 1, to assist in collecting dust and prevent dust from escaping. The motor 6 can drive the fixed disk bracket 2 to rotate through coupling, allowing the Velcro polishing disc 3 to polish the wall surface.

The delivery pipe 8 can deliver dust air from the elastic dust cover 1 to the installation cover 7, while the exhaust impeller 10 rotates under the drive of the transmission shaft 9, generating negative pressure and drawing dust into the exhaust dust system 12.

The operator holds the grip rod 17, and starts the motor 6 through the switch power supply 18. The motor 6 drives the fixed disk bracket 2 and the Velcro polishing disc 3 to rotate at high speed. At the same time, the exhaust impeller 10 is started, which rotates to create negative pressure inside the installation cover 7, the delivery pipe 8 and the elastic dust cover 1.

When the grinding disc comes into contact with the wall for polishing, the generated dust is sucked into the elastic dust cover 1 under the negative pressure. After being initially blocked by the annual brush 4, most of the dust enters the installation cover 7 through the delivery pipe 8 with the airflow. In the installation cover 7, the exhaust impeller 10 further accelerates the dust into the exhaust dust system 12 and finally discharges it into the collection device (such as a dust collecting sleeve).

The elastic dust cover 1 automatically adjusts its shape according to the flatness of the wall, always maintaining a tight fit with the wall to prevent dust leakage. The wear plate 5 can reduce the wear of the elastic dust cover 1 during contact with the wall. The annular LED light 13 can provide illumination for operators in low light conditions. The vent valve 11 is controlled by the vent valve switch 15 to open and close, balancing the internal air pressure of the device.

Compared with related technologies, the dustproof structure for wall polisher of the present disclosure has at least the following beneficial effects.

The dustproof structure for wall polisher of the present disclosure, by setting the elastic dust cover on the entire device, it can be used to fit with uneven walls according to their shape when the entire device polishes the wall. Moreover, by setting the wear plate on one side of the elastic dust cover, so that the device can drive the elastic dust cover to come into contact with the wall for polishing for a long time, this can reduce the wear of the elastic dust cover and causing gaps between the elastic dust cover and the wall, and also can avoid resulting in leakage and falling of wall powder during the polishing process.

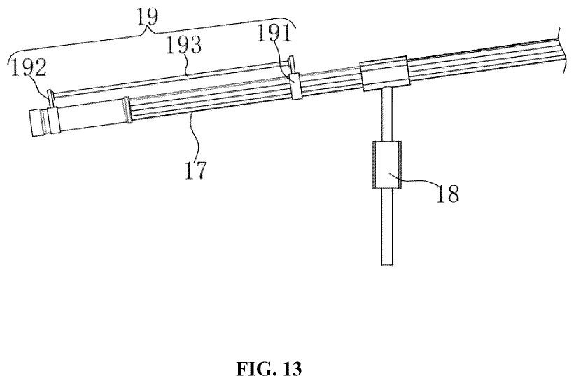

Referring to FIG. 13, in some other embodiments of the present disclosure, a dustproof structure for wall polisher is provided. It should be understood that such embodiments are only some preferred embodiments, and their implementation will not affect the separate implementation of the above embodiments.

Specifically, the difference in the dustproof structure for wall polisher of the preferred embodiments lies in the following. The surface of the grip rod 17 is provided with a limit component 19, the limit component 19 includes two fixed rings 191, two fixed blocks 192, and a limit rod 193. Where the two fixed blocks 192 are respectively connected to surfaces of the two fixed rings 191, the limit rod 193 is connected between the two fixed blocks 192, and the two fixed rings 191 are symmetrically installed on both sides of the surface of the grip rod 17.

There is a distance between the limit rod 193 and the grip rod 17 to facilitate the placement of hands.

The working principle of the dustproof structure for wall polisher of the present disclosure is described as follows.

The dustproof structure for wall polisher of the present disclosure, by setting the limit component 19 on the surface of the grip rod 17, which can prevent detachment between the operator and the grip rod 17 during a long time use of the device.

The above description is only some embodiments of the present disclosure, and does not limit the patent scope of the present disclosure. Any equivalent structure or equivalent process made by using the content of the specification and drawings of the present disclosure, or directly or indirectly applied in other related technical fields, are also included in the patent protection scope of the present invention.

What is claimed is:

1. A dustproof structure for wall polisher, comprising:
an elastic dust cover, provided with a fixed disk bracket inside, wherein a Velcro polishing disc is bonded to a bottom of the fixed disk bracket, an annular brush is provided between the fixed disk bracket and the elastic dust cover, a wear plate is provided at a bottom of the elastic dust cover, a motor is installed at a center position of a surface of the elastic dust cover, and one end of an output shaft of the motor is connected to the fixed disk bracket through a coupling;
an installation cover, installed on a surface of the motor, wherein one side of the installation cover is provided with a delivery pipe connected to the elastic dust cover, a transmission shaft is provided inside the installation cover, and an exhaust impeller is connected to a top of the transmission shaft; and
an exhaust dust system, connected to the one side of the installation cover, and one end of the exhaust dust system is connected with a grip rod.

2. The dustproof structure for wall polisher according to claim 1, wherein the one side of the installation cover is installed with a vent valve.

3. The dustproof structure for wall polisher according to claim 2, wherein a rotatable holder is provided between the vent valve and the grip rod.

4. The dustproof structure for wall polisher according to claim 1, wherein the surface of the elastic dust cover is provided with an annular LED light and the surface of the elastic dust cover is further provided with a LED light switch.

5. The dustproof structure for wall polisher according to claim 1, wherein the surface of the elastic dust cover is provided with a vent valve switch.

6. The dustproof structure for wall polisher according to claim 1, wherein a surface of the grip rod is provided with a switch power supply.

7. The dustproof structure for wall polisher according to claim 1, wherein a surface of the grip rod is provided with a limit component, the limit component comprises two fixed rings, two fixed blocks, and a limit rod; wherein the two fixed blocks are respectively connected to surfaces of the two fixed rings, the limit rod is connected between the two fixed blocks, and the two fixed rings are symmetrically installed on both sides of the surface of the grip rod.
